(19) United States
(12) Patent Application Publication
(10) Pub. No.: US 2014/0098230 A1
(43) Pub. Date: Apr. 10, 2014

(54) BLIND ZONE DETECTION AND ALERT SYSTEM FOR VEHICLE

(71) Applicant: MAGNA MIRRORS OF AMERICA, INC., Holland, MI (US)

(72) Inventor: Michael J. Baur, Holland, MI (US)

(73) Assignee: MAGNA MIRRORS OF AMERICA, INC., Holland, MI (US)

(21) Appl. No.: 14/047,356

(22) Filed: Oct. 7, 2013

Related U.S. Application Data
(60) Provisional application No. 61/710,922, filed on Oct. 8, 2012.

(51) Int. Cl. B60Q 1/00; B60R 1/00

(52) U.S. Cl. CPC B60Q 1/00; B60R 1/00
USPC 348/148; 340/435

(57) ABSTRACT

An alert system for a vehicle includes a sensor and a control. The sensor is disposed at a side portion of a vehicle and has at least a generally sidewardly and rearwardly sensing direction. The control is operable to process an output of the sensor to determine if an object of interest is present in the sensing region at or near the side of the vehicle. Responsive to at least one of (i) the vehicle being stopped, (ii) the vehicle transmission being shifted into park and (iii) the vehicle ignition being turned off, the control is operable to process the sensor output to detect an object at or near the side of the vehicle or approaching the vehicle along the side of the vehicle, and, responsive to detection of such an object, the alert system generates an alert to an occupant of the vehicle.

### CROSS REFERENCE TO RELATED APPLICATION

The present application is related to U.S. provisional application Ser. No. 61/710,922, filed Oct. 8, 2012, which is hereby incorporated herein by reference in its entirety.

### FIELD OF THE INVENTION

The present invention relates to blind zone detection systems for vehicles.

### BACKGROUND OF THE INVENTION

It is known to provide an object in a blind spot detection/LCA system for a vehicle that detects the presence of another vehicle or object in the lane next to the host vehicle, where it may be difficult for the driver of the host vehicle to determine whether or not there is another vehicle or object adjacent to the host vehicle. Such an object in a blind spot detection/LCA system often includes a visual indicator that visually indicates the detection of another vehicle or object to the driver of the host vehicle. The visual indicator or indicators (commonly a light emitting diode or the like) of such systems is/are often located at the mirror reflective element of the exterior rearview mirror assembly.

### SUMMARY OF THE INVENTION

The present invention provides a blind zone detection system that is operable to detect objects present sidewardly and/or rearwardly of the equipped vehicle. The system is operable to generate an alert when an object is detected at or near or approaching the equipped vehicle, and optionally may be responsive to a lane change maneuver of the equipped vehicle. The blind zone system of the present invention is operable to, when the equipped vehicle is stationary, detect objects, such as a bicycle or a pedestrian or the like, present at the side of the vehicle, and may generate an alert to the driver and/or passenger and/or passengers of the vehicle to warn them to not open their door so as to limit or substantially preclude opening their door into the path of the cyclist or pedestrian or the like.

The blind zone detection system of the present invention may utilize aspects of the blind zone systems and indicators described in U.S. Pat. Nos. 7,944,371; 7,720,580; 7,581,859; 7,038,577; 6,882,287; 6,198,409; 5,929,786; and/or 5,786,772, and/or U.S. patent application Ser. No. 11/226,628, filed Sep. 14, 2005 and published Mar. 23, 2006 as U.S. Publication No. US-2006-0061008, and/or International Publication Nos. WO 2007/005942, WO 2006/124682, and/or WO 2008/051910, which are all hereby incorporated herein by reference in their entireties.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle equipped with a blind zone detection system in accordance with the present invention.

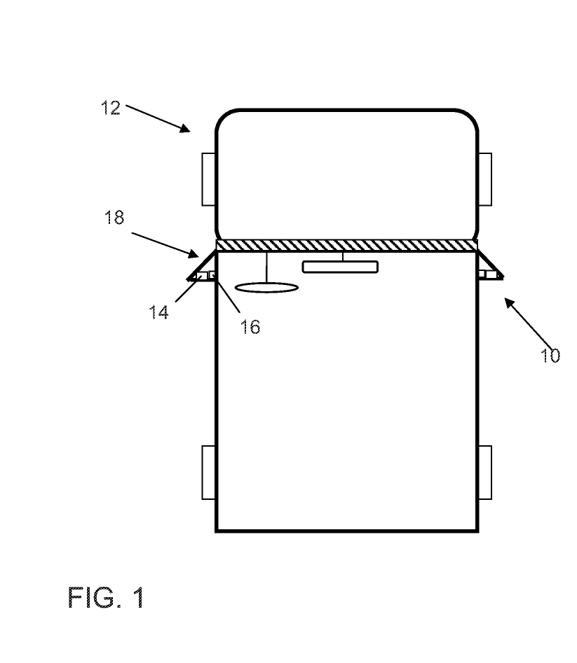

### DESCRIPTION OF THE PREFERRED EMBODIMENTS

Referring now to the drawings and the illustrative embodiments depicted therein, a blind zone detection system or side object detection system 10 of a vehicle 12 includes a sensor 14 at one or both sides of the vehicle 12, whereby the sensor has a field of view or sensing that encompasses an area sideward and/or rearward of the vehicle 12 at the respective side of the vehicle. The sensor or sensors may comprise any suitable sensor, such as an image-based sensor or imaging sensor or camera or such as a radar sensor or lidar sensor or ultrasonic sensor or time-of-flight sensor or the like. The system is operable to detect objects at or near the side of and/or rearward of the vehicle, such as to provide an alert or warning to the driver of the vehicle when the driver of the vehicle is making a lane change into a lane already occupied by another vehicle or rearwardly approaching vehicle. The system of the present invention is operable, when the vehicle is stationary with an occupant in the vehicle, to remain active to detect objects at or near or approaching the side of the vehicle when the vehicle is parked, and, responsive to detection of such an object, the system may generate an alert or warning to the driver or occupant of the vehicle and/or to the detected object (such as a cyclist or pedestrian at or near the side of the vehicle) to alert the occupant and/or cyclist of a potentially hazardous condition if the vehicle door is opened at that side of the vehicle, as discussed below.

The sensor may comprise any suitable sensor (and may be disposed at an exterior rearview mirror assembly of the vehicle or the like) and the system may include a control that processes an output of the sensor to determine if an object of interest is present at or near or approaching the side lane adjacent to the vehicle. For example, the system may include an image processor that is operable to process image data captured by a camera or image sensor to detect or determine the presence of and/or approach of an object at or near the side of the vehicle at which the sensor or camera is disposed. The camera and image processor may comprise any suitable image capture and processing system, and may utilize aspects of the imaging systems and object detection systems described in U.S. Pat. Nos. 5,550,677; 5,760,962; 5,670,935; 5,715,093; 5,796,094; 5,877,897; 6,201,642; 6,396,397; 6,498,620; 6,717,610; 6,757,109; 7,005,974; 7,526,103; 6,250,148; 6,341,523; 6,353,392; 6,313,454; 5,550,677; 5,760,962; 6,097,023; 5,796,094; 8,058,977; 7,881,496; 7,720,580; 7,581,859; 7,492,281; 7,195,381; 7,038,577; 6,902,284; 6,882,287; 6,690,268; 6,198,409; 5,929,786; and 5,786,772, and/or U.S. patent applications, Ser. No. 11/226,628, filed Sep. 14, 2005 and published Mar. 23, 2006 as U.S. Publication No. US-2006-0061008; and/or Ser. No. 12/187,725, filed Aug. 7, 2008 and published Feb. 12, 2009 as U.S. Publication No. US-2009-0040306, and/or International Publication Nos. WO 2011/028686; WO 2010/099416; WO 2012/061567; WO 2012/068331; WO 2012/075250; WO 2012/103193; WO 2012/0116043; WO 2012/0145313; WO 2012/0145501; WO 2012/145818; WO 2012/145822; WO 2012/158167; WO 2012/075250; WO 2012/103193; WO 2012/0116043; WO 2012/0145501; WO 2012/0145343; WO 2012/154919; WO 2013/019707; WO 2013/016409; WO 2012/145822; WO 2013/067083; WO 2013/070539; WO 2013/043661; WO 2013/048994; WO 2013/063014, WO 2013/081984; WO 2013/081985; WO 2013/074604; WO 2013/086249; WO 2013/103548; WO 2013/109869; WO 2013/123161; WO 2013/126715; WO 2007/005942, WO 2006/124682, and/or WO 2008/051910, which are all hereby incorporated herein by reference in their entireties. For example, the image processor may comprise an EyeQ2 or EyeQ3 image processing chip available from Mobileye Vision Technologies Ltd. of Jerusalem, Israel, and may include object detection software (such as the types described in U.S. Pat. Nos. 7,855,755; 7,720,580; and/or 7,038,577, which are hereby incorporated herein by reference in their entireties), and may analyze image data to detect vehicles and/or other objects.

When the vehicle is stationary (such as when the vehicle is not moving or when the vehicle transmission is shifted into park or when the vehicle ignition is turned off) and with an occupant in the vehicle, the system operates to detect a cyclist or pedestrian or other object or vehicle the like at or near or approaching the side of the vehicle. When the system is active in this manner and detects a cyclist or pedestrian or the like at or near or approaching the side of the vehicle, the system may generate an alert to the occupant or occupants of the vehicle to warn the occupant or occupants to not open the vehicle door or doors due to the presence of or approach of a detected object at or near or approaching the vehicle or vehicle door. For example, the system may generate and alert or indicator at the window or door at or near where the object was detected or an alert or indicator may be generated at the interior rearview mirror assembly or the like of the vehicle, and/or an audible alert may be generated to alert the occupant or occupants of the vehicle of the potential hazard if the door is opened. The alert may also indicate the side of the vehicle at which the object is detected so the occupants know which door of the vehicle should not be opened at that time.

Optionally, for example, the system may generate an alert or indication, such as via having an indicator 16 in the sideview mirror assembly 18 or an indicator at the door, such as at the door window or door handle or interior trim panel of the door, flash or illuminate or otherwise be highlighted. Optionally, the alert or indicator may be disposed at an exterior sideview or rearview mirror assembly at the side of the vehicle, whereby actuation of the indicator (which may be disposed behind the reflective element of the mirror assembly and viewable through the reflective element) allows both the driver (or other occupant) and the detected cyclist or pedestrian or the like to observe the potential danger before the vehicle door is opened.

The system may be kept on or “hot” with or without the ignition on until such time as the vehicle cabin is determined to be unoccupied. For example, the system may remain activated and operable to detect objects for a period of time following an ignition off condition when the vehicle is stopped or parked, and/or may remain activated for a period of time following the shifting of the vehicle into park or the like. Optionally, the system may also be responsive to a cabin monitoring system, and may operate in the door opening alert mode when the vehicle is stopped or parked or off and when the cabin monitoring system detects an occupant in the vehicle. Optionally, the system may receive a signal indicative of the vehicle status (stopped or in park or ignition off or the like) via a vehicle network bus or the like.

Optionally, the alert may be provided at the door or exterior mirror at the side of the vehicle at or near where the object is detected, so as to warn occupants on that side of the vehicle to not open their doors, while allowing occupants on the other side of the vehicle to open their doors. Optionally, the system may further include a door limiting or locking function to at least temporarily delay opening of the door when a potential collision with a cyclist or object is detected. For example, the system may lock the door or may require the door handle to be actuated two or more times or the like before the door will open when a detected hazardous condition exists.

Therefore, the present invention provides a blind zone detection system or side object detection system that is operable to detect objects (such as a bicycle or pedestrian or the like) at or near or approaching the side of the vehicle when the vehicle is stopped or parked, and may generate an alert to the occupant of the vehicle to warn the occupant to not open the vehicle door when an object is detected at or near or approaching that side of the vehicle. The system may operate in a door opening warning or alert mode responsive to a determination that the vehicle has stopped (such as responsive to a vehicle status signal indicative of the vehicle being stopped or in park or turned off or the like), and may continue to operate in that mode for a period of time after stopping or parking of the vehicle. The system may operate in the door opening warning or alert mode only when an occupant is in the vehicle (such as responsive to a cabin monitoring system or the like).

Thus, the alert system of the present invention may include a sensor (such as an image-based sensor, a radar sensor, lidar sensor, an ultrasonic sensor, a time-of-flight sensor or the like) disposed at a side portion of a vehicle and having at least a generally sidewardly and rearwardly sensing direction. The control of the alert system is operable to process an output of the sensor (such as, for example, image processing of image data captured by an image sensor or camera) to determine if an object of interest is present in the sensing region at or near the side of the vehicle. Responsive to at least one of (i) the vehicle being stopped (such as responsive to a wheel sensor or the like of the vehicle that generates a signal or output that is indicative of the vehicle moving or stopped), (ii) the vehicle transmission being shifted into park (such as responsive to a shift interlock sensor or park sensor or the like of the vehicle) and (iii) the vehicle ignition being turned off (such as responsive to an ignition on/off sensor or the like), the control is operable to process the sensor output to determine or detect the presence an object at or near the side of the vehicle or approaching the vehicle along the side of the vehicle, and, responsive to detection of an object at or near the side of the vehicle or approaching the vehicle along the side of the vehicle, the alert system generates an alert to an occupant of the vehicle.

The control may be operable to detect a cyclist or pedestrian at or near or approaching the side of the vehicle and the alert system may be operable to alert the occupant of a potential hazard if the vehicle door at that side of the vehicle is opened. The alert may comprise at least one of an audible alert and a visual alert within the vehicle cabin, and/or the alert may comprise at least a visual alert at an exterior portion of the vehicle (such as an indicator disposed at an exterior rearview mirror assembly of the vehicle) and viewable by a person at or near or approaching the vehicle at that side of the vehicle.

The control may be operable to process the sensor output to detect an object at or near the side of the vehicle or approaching the vehicle along the side of the vehicle for a period of time following at least one of (i) the vehicle being stopped, (ii) the vehicle transmission being shifted into park and (iii) the vehicle ignition being turned off. For example, after the system is triggered (such as via detection of the stopping of the vehicle or shifting to park or ignition off), the system may monitor the side region to detect objects, and may continue to monitor the side region for at least ten seconds following the triggering action or event, or for at least twenty seconds of more following the triggering action or event. At the end of the monitoring period following the triggering action or event, the system may be deactivated. The control may be further responsive to a detection of the occupant within the vehicle, such that the alert system operates to detect an object at or near or approaching the side of the vehicle and to generate an alert when such an object is detected only when the system determines that there is an occupant in the vehicle (so as to avoid generating an alert when there is no one in the vehicle and thus no risk that a vehicle occupant will open the door). The system may deactivate following the monitoring period of time after the triggering action or event, and/or may deactivate when or after the occupant has opened the door and left the vehicle.

The blind zone detection system and indicator (particularly for an indicator at an exterior rearview mirror assembly of the vehicle) may utilize aspects of the indicators and systems and sensors and components described in U.S. Pat. Nos. 5,550,677; 5,760,962; 5,670,935; 5,715,093; 5,796,094; 5,877,897; 6,201,642; 6,396,397; 6,498,620; 6,717,610; 6,757,109; 7,005,974; 7,526,103; 6,250,148; 6,341,523; 6,353,392; 6,313,454; 5,550,677; 5,760,962; 6,097,023; 5,796,094; 8,058,977; 7,881,496; 7,720,580; 7,581,859; 7,492,281; 7,195,381; 7,038,577; 6,902,284; 6,882,287; 6,690,268; 6,198,409; 5,929,786; and 5,786,772, and/or U.S. patent applications, Ser. No. 11/226,628, filed Sep. 14, 2005 and published Mar. 23, 2006 as U.S. Publication No. US-2006-0061008; and/or Ser. No. 12/187,725, filed Aug. 7, 2008 and published Feb. 12, 2009 as U.S. Publication No. US-2009-0040306, and/or International Publication Nos. WO 2007/005942, WO 2006/124682, and/or WO 2008/051910, which are all hereby incorporated herein by reference in their entireties.

The reflective element of the side mounted vehicular rearview mirror assembly may comprise an electro-optic or electrochromic reflective element or cell, such as an electrochromic mirror assembly and electrochromic reflective element utilizing principles disclosed in commonly assigned U.S. Pat. Nos. 7,274,501; 7,255,451; 7,195,381; 6,690,268; 6,420,036; 5,140,455; 5,151,816; 6,178,034; 6,154,306; 6,002,511; 5,567,360; 5,525,264; 5,610,756; 5,406,414; 5,253,109; 5,076,673; 5,073,012; 5,115,346; 5,724,187; 5,668,663; 5,910,854; 5,142,407; and/or 4,712,879, and/or U.S. patent application Ser. No. 11/226,628, filed Sep. 14, 2005 and published Mar. 23, 2006 as U.S. Publication No. US-2006-0061008, and/or PCT Application No. PCT/US2006/018567, filed May 16, 2006 and published Nov. 23, 2006 as International Publication No. WO 2006/124682, which are all hereby incorporated herein by reference in their entireties.

Optionally, the reflective element may include a perimeter metallic band, such as the types described in U.S. Pat. Nos. 7,255,451; 7,274,501 and/or 7,184,190, and/or U.S. patent application Ser. No. 11/226,628, filed Sep. 14, 2005 and published Mar. 23, 2006 as U.S. Publication No. US-2006-0061008, which are all hereby incorporated herein by reference in their entireties. Optionally, the reflective element may include indicia formed at and viewable at the reflective element, such as by utilizing aspects of the reflective elements described in U.S. Pat. No. 7,626,749, which is hereby incorporated herein by reference in its entirety.

Optionally, the reflective element may comprise a single substrate with a reflective coating at its rear surface, without affecting the scope of the present invention. The mirror assembly thus may comprise a prismatic mirror assembly or planar or non-planar mirror or multi-radius or other mirror having a single substrate reflective element, such as a mirror assembly utilizing aspects described in U.S. Pat. Nos. 7,249,860; 6,318,870; 6,598,980; 5,327,288; 4,948,242; 4,826,289; 4,436,371; and/or 4,435,042; and/or PCT Application No. PCT/US04/015424, filed May 18, 2004 and published Dec. 2, 2004 as International Publication No. WO 2004/103772, which are hereby incorporated herein by reference in their entireties.

Optionally, the indicator or alert may be provided via one or more displays, such as by utilizing aspects of the displays and display elements of the types disclosed in U.S. Pat. Nos. 5,530,240; 6,329,925; 6,690,268; 5,668,663; 5,724,187; 7,195,381; 7,274,501; 7,184,190; 7,370,983; and/or 7,255,451; and/or U.S. patent application Ser. No. 10/538,724, filed Jun. 13, 2005 and published Mar. 9, 2006 as U.S. Publication No. US-2006-0050018, which are hereby incorporated herein by reference in their entireties. The display may be operable to display a status of the alert system and may display an icon or image of a detected object to alert the occupant of the determined presence of an object. The display may flash or otherwise adjust the display to draw the viewer's attention to the detected object when the system determines that the detected object may present a hazard to a person opening one of the doors of the vehicle at the side of the vehicle where the object is detected.

Changes and modifications to the specifically described embodiments may be carried out without departing from the principles of the present invention, which is intended to be limited only by the scope of the appended claims as interpreted according to the principles of patent law.

1. An alert system for a vehicle, said alert system comprising:
a sensor disposed at a side portion of a vehicle and having at least a generally sidewardly and rearwardly sensing direction;
a control operable to process an output of said sensor to determine if an object of interest is present in the sensing region at or near the side of the vehicle; and
wherein, responsive to at least one of (i) the vehicle being stopped, (ii) the vehicle transmission being shifted into park and (iii) the vehicle ignition being turned off, said control is operable to process said sensor output to detect an object at or near the side of the vehicle or approaching the vehicle along the side of the vehicle, and, responsive to detection of an object at or near the side of the vehicle or approaching the vehicle along the side of the vehicle, said alert system generates an alert to an occupant of the vehicle.

2. The alert system of claim 1, wherein said control is operable to detect a cyclist or pedestrian at or near or approaching the side of the vehicle and said alert system is operable to alert the occupant of a potential hazard if the vehicle door at that side of the vehicle is opened.

3. The alert system of claim 1, wherein said alert comprises at least one of an audible alert and a visual alert within the vehicle cabin.

4. The alert system of claim 1, wherein said alert comprises at least a visual alert at an exterior portion of the vehicle and viewable by a person at or near or approaching the vehicle at that side of the vehicle.

5. The alert system of claim 4, wherein said alert comprises an indicator disposed at an exterior rearview mirror assembly of the vehicle.

6. The alert system of claim 1, wherein said control is operable to process said sensor output to detect an object at or near the side of the vehicle or approaching the vehicle along the side of the vehicle for a period of time following at least one of (i) the vehicle being stopped, (ii) the vehicle transmission being shifted into park and (iii) the vehicle ignition being turned off.

7. The alert system of claim 6, wherein said control is further responsive to a detection of the occupant within the vehicle.

8. The alert system of claim 1, wherein said sensor comprise at least one of an image-based sensor, a radar sensor, lidar sensor, an ultrasonic sensor and a time-of-flight sensor.

9. An alert system for a vehicle, said alert system comprising:
a camera disposed at a side of a vehicle and having a field of view in at least a generally sidewardly and rearwardly direction at the side of the vehicle;
a control operable to process image data captured by said camera to determine if an object of interest is present in the field of view at or near the side of the vehicle; and
wherein, responsive to at least one of (i) the vehicle being stopped, (ii) the vehicle transmission being shifted into park and (iii) the vehicle ignition being turned off, said control is operable to process captured image data to detect an object at or near the side of the vehicle or approaching the vehicle along the side of the vehicle, and, responsive to detection of an object at or near the side of the vehicle or approaching the vehicle along the side of the vehicle, said alert system generates an alert to an occupant of the vehicle to alert the occupant of a potential hazard if the vehicle door at that side of the vehicle is opened.

10. The alert system of claim 9, wherein said control is operable to detect a cyclist or pedestrian at or near or approaching the side of the vehicle and said alert system is operable to alert the occupant of the vehicle.

11. The alert system of claim 9, wherein said alert comprises at least one of an audible alert and a visual alert within the vehicle cabin.

12. The alert system of claim 9, wherein said alert comprises at least a visual alert at an exterior portion of the vehicle and viewable by a person at or near or approaching the vehicle at that side of the vehicle.

13. The alert system of claim 12, wherein said alert comprises an indicator disposed at an exterior rearview mirror assembly of the vehicle.

14. The alert system of claim 9, wherein said control is operable to process captured image data to detect an object at or near the side of the vehicle or approaching the vehicle along the side of the vehicle for a period of time following at least one of (i) the vehicle being stopped, (ii) the vehicle transmission being shifted into park and (iii) the vehicle ignition being turned off.

15. The alert system of claim 14, wherein said control is further responsive to a detection of the occupant within the vehicle.

16. An alert system for a vehicle, said alert system comprising:
a sensor disposed at a side portion of a vehicle and having at least a generally sidewardly and rearwardly sensing direction, wherein said sensor comprise at least one of an image-based sensor, a radar sensor, lidar sensor, an ultrasonic sensor and a time-of-flight sensor;
a control operable to process an output of said sensor to determine if an object of interest is present in the sensing region at or near the side of the vehicle; and
wherein, responsive to at least one of (i) the vehicle being stopped, (ii) the vehicle transmission being shifted into park and (iii) the vehicle ignition being turned off, said control is operable to process said sensor output to detect an object at or near the side of the vehicle or approaching the vehicle along the side of the vehicle, and, responsive to detection of an object at or near the side of the vehicle or approaching the vehicle along the side of the vehicle, said alert system generates an alert to an occupant of the vehicle to alert the occupant of a potential hazard if the vehicle door at that side of the vehicle is opened.

17. The alert system of claim 16, wherein said alert comprises at least one of (i) an audible alert within the vehicle cabin, (ii) a visual alert within the vehicle cabin and (iii) a visual alert at an exterior portion of the vehicle and viewable by a person at or near or approaching the vehicle at that side of the vehicle.

18. The alert system of claim 16, wherein said alert comprises an indicator disposed at an exterior rearview mirror assembly of the vehicle.

19. The alert system of claim 16, wherein said control is operable to process said sensor output to detect an object at or near the side of the vehicle or approaching the vehicle along the side of the vehicle for a period of time following at least one of (i) the vehicle being stopped, (ii) the vehicle transmission being shifted into park and (iii) the vehicle ignition being turned off.

20. The alert system of claim 16, wherein said control is further responsive to a detection of an occupant within the vehicle and wherein, responsive to detection of an occupant within the vehicle, said control is operable to process said sensor output to detect an object at or near the side of the vehicle or approaching the vehicle along the side of the vehicle.
